(19) United States
(12) Patent Application Publication
(10) Pub. No.: US 2020/0334966 A1
(43) Pub. Date: Oct. 22, 2020

(54) Mercury switch

(71) Applicant: James Andrew Bentley, Alabany, GA (US)

(72) Inventor: James Andrew Bentley, Alabany, GA (US)

(21) Appl. No.: 16/389,958

(22) Filed: Apr. 21, 2019

(51) Int. Cl. G08B 17/12; H01H 37/74

(52) U.S. Cl. CPC G08B 17/12; H01H 37/74

(57) ABSTRACT

This device is a Mercury Switch used to detect rapid temperature spikes and possible fire in a room or around the device. It is to be placed in a cell phone and or other electrical and mobile devices.

### FIELD

The present application relates to a Mercury Switch as a fire detector for a cell phone

### BACKGROUND

This device is to detect a rapid temperature spike in the air around the cell phone causing the mercury to rise, connecting the two diodes completing the circuit causing the alarm to go off alerting you to a possible fire or hazard environment within the vicinity of the cell phone.

### SUMMARY

By providing this device it is designed to be able to detect fire near a computer, cell phone, or any electrical or cellular device.

### BRIEF DESCRIPTION OF THE DRAWINGS

In the following detailed portion of the present description, the teachings of the present application will be explained in more detail with reference to the example embodiments shown in the drawings, in which:

FIG. 1 is an isometric view of a device according to a first embodiment.

### DETAILED DESCRIPTION

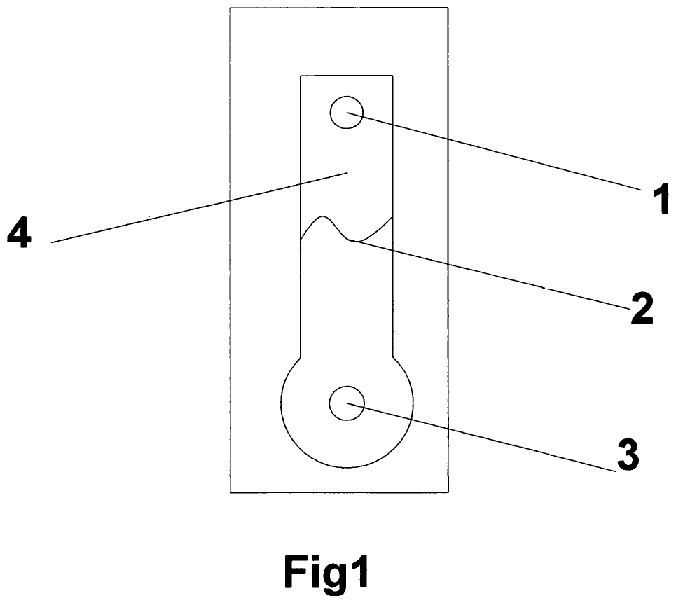

FIG. 1 Number 1 is an electrical diode. Number 2 is the mercury inside the glass containment tube. Number 3 is an electrical diode that is always in contact with the mercury. Number 4 is a glass containment tube containing two diodes and mercury.

It should be noted that even though only a mobile phone is described in the application, other electronic devices such as cameras, computers, T.V.'s and any other electrical devices and or mobile devices can utilize this technology.

1. A device comprising of a glass tube with two electrical diodes in it. One at the top and one at the bottom filled with mercury at the bottom of the glass bulb.

2. This device is a Mercury Switch. As the temperature rises the mercury rises to the top of the electrical diode completing an electrical circuit sounding an alarm letting you know there is a potential fire or hazardous environment in the room or the area around the device.

3. This device can also be used not only for a cellular phone but a computer, a T.V., a camera, and any other electrical and or mobile device.
